(19) United States
(12) Patent Application Publication
(10) Pub. No.: US 2016/0047371 A1
(43) Pub. Date: Feb. 18, 2016

(54) Apparatus and Method for Processing Coating Compositions

(71) Applicant: Fluid Management Operations LLC, Wheeling, IL (US)

(72) Inventor: Johannes Hermanus Nicolaas POST, NM Sassenheim (NL)

(21) Appl. No.: 14/775,394

(22) PCT Filed: Mar. 13, 2014
(86) PCT No.: PCT/EP2014/055015

§ 371 Date: Sep. 11, 2015

Related U.S. Application Data
(63) Continuation of application No. 13/833,961, filed on Mar. 15, 2013, now abandoned.

(51) Int. Cl. F04B 49/06; F04B 17/03; B01F 15/00; B01F 3/12; B01F 7/16

(52) U.S. Cl. CPC F04B 49/06; B01F 3/1221; B01F 7/16; B01F 15/00448; F04B 17/03; B01F 2215/005

(57) ABSTRACT

A method and apparatus for processing coating compositions. The apparatus comprises:
at least one liquid displacement device, such as a dispenser pump or a stirrer, e.g. of a paint delivery system;
at least one sensor for determining flow behaviour of a coating composition in the liquid displacement device during operation of the liquid displacement device
a control unit responsive to output signals from the sensor to generate a parameter representing rheological quality of the coating composition.

The apparatus may for instance comprise a motor for driving the liquid displacement device, wherein the sensor includes at least one sensor for determining one or more motor performance parameters corresponding to resistance encountered by the motor.

### BACKGROUND

The present disclosure pertains to an apparatus and a method for processing coating compositions, in particular liquid or powder paints, lacquers, stains, dye compositions or colorants, such as liquid or powder colorant concentrates, pigments dispersions, pigment pastes for tinting paints. The apparatus can for instance be or comprise a dispenser and/or a container with a stirrer, e.g., of a paint delivery system.

### DESCRIPTION OF THE RELATED ART

Paint delivery systems typically make use of a number of different components, such as base paints, pigment pastes or paint modules, to formulate a desired paint composition. Each component is contained in a separate container connected or connectable to a dispense pump. The containers and the pumps may for example be disposed on a turntable or along one or more stationary horizontal rows. An example of such a paint delivery system is disclosed in U.S. Pat. No. 6,003,731.

To deliver a paint of the desired colour or composition, the selected components should be metered accurately. Exact metering is complicated by variance of the flow characteristics of the components with temperature, shear and time.

The required pump drive capacity of the dispense pump depends on flow characteristics of the liquid to be dispensed and dosing speed. With coating compositions these flow characteristics typically change over time due to aging and sagging. This results in inaccurate metering and dispensing of the pigment dispersion and, in the end, an incorrect final paint colour or quality.

Coating compositions typically comprise binder components or resins, which may tend to bind or cure during long-term storage in the container. After a while the condition of the coating composition can become such that the pump capacity becomes too low and the pump drive system is not able to perform the requested action. In extreme cases the coating composition can become of such a bad condition that it has to be replaced. This requires labour-intensive and expensive cleaning of the container and associated equipment by a service engineer. It is desirable to be able to notice aging of the dispersions in an early stage.

Exact metering of the selected paint components during paint formulation can be hindered if one of the containers holding one of the selected pigment dispersions can become empty before the desired quantity of the dispersion could be dispensed.

Accordingly, there is a need for an apparatus or method for processing coating compositions, in particular paints or pigment dispersions, enabling to monitor the condition of the used coating composition components, e.g., to enable more exact metering or to reduce the risk of interruption of the paint formulation process due to the need to replace or refill a used coating composition component.

### SUMMARY OF THE DISCLOSURE

An apparatus is disclosed for processing coating compositions, such as paints, paint modules or pigment dispersions. The apparatus comprises:

at least one liquid displacement device, such as a dispenser pump or a stirrer, e.g. of a paint delivery system;

at least one sensor for determining flow behaviour of a coating composition in the liquid displacement device during operation of the liquid displacement device

a control unit responsive to output signals from the sensor to generate a parameter representing rheological quality of the coating composition.

The apparatus may for instance comprise a motor for driving the liquid displacement device, wherein the sensor includes at least one sensor for determining one or more motor performance parameters corresponding to resistance encountered by the motor.

The sensor can for example include a load cell or other suitable measuring unit measuring torque exerted by the motor, an encoder determining rotation by the rotor of the motor, a home sensor or reset sensor determining when the rotor of the motor returns to a defined home position, and/or a current measurement circuit measuring current consumed by the motor, or any other sensoring device suitable for determining motor performance parameters.

In this respect it is noted that in WO 98/16880 a pump system is disclosed comprising a pressure transducer measuring fluid pressure. It does not disclose measurement of a motor performance parameter.

Disclosures relating to motor control using measured motor performance feedback outside the field of coating composition processing, include U.S. Pat. No. 6,709,240 and U.S. 2004/0090197 disclosing a centrifugal pump wherein voltage and current data are detected from voltage and current sensors in the pump motor. A power signal is then generated from the voltage and current data and spectrally analyzed to determine the low flow or mechanical disturbances in the pump. U.S. Pat. No. 5,396,167 discloses a method for determining operability of a motor operated valve combination sensing the real motor power of the motor as a function of time. DE 195 36 823 discloses a testing device for detecting operational parameters of a dosing pump with a measuring device for a path-related measured variable. Systems for detecting failures and occlusions in pump systems are for example disclosed in U.S. 2004/0085215, EP 1 510 804 and U.S. 2005/0089407.

The determined parameter can be used to provide feedback information on the status of the coating composition to be processed. This feedback information can for example be used to give information about the condition of the liquid, batch status information to a supplier, operator instructions, service instructions, signalling blockage of associated valves or tubes, or alerting signals to empty and clean the container. The feedback information can also be used to adjust the motor performance.

The control unit can for example be configured to control the speed of the motor on basis of the determined torque. If the speed changes, the control unit is programmed to generate a feedback signal on basis of the change in electric current consumed by the motor resulting from the change of speed. This signal is indicative for the condition of the processed liquid.

The liquid displacement device can for example be or include a pump. In that case, the parameter can be determined during a displacement stroke by the pump. The control unit is programmed to compare the determined parameter with a set value as a function of time. The time can be represented in units of time (seconds) or number of steps in case a stepper motor is used.

The pump can be part of a dispenser, such as a dispenser of a paint delivery system.

AC or DC electromotors, in particular stepper motors, are typically suitable for such dispensers, allowing exact metering. An electromotor can be provided with an encoder. Such an encoder can be used as a sensor determining the amount of rotation of the rotor of the stepper motor by counting the number of steps. In that case, the control unit can be programmed to adjust power feed to the motor if the determined rotation of the motor deviates from a set value. The control unit can then be programmed to calculate a signal indicative for the condition of the coating composition on basis of the difference between the determined rotation and the set value.

Optionally, a stepper motor can be used provided with a home sensor and/or an absolute encoder, using the number of steps required to return the rotor of the stepper motor to a defined home position as the parameter.

With a stepper motor feedback on the motor can also be achieved by retrieving rotational information from the stepper motor itself, e.g., instead of—or in addition to—information from an encoder or similar position sensor. This can for instance be achieved by using motor-current monitoring as a reflection of back electromotive force (BEMF). Motor torque is directly proportional to motor current. Motor current is influenced by BEMF, so by monitoring BEMF motor torque can be determined BEMF is absent during a stall. The absence of BEMF increases the potential current in a winding at a given voltage. Since the rate of change of current in an inductor is proportional to the voltage across the inductor, the rate of change of current in the windings is larger if there is less BEMF. In other words, with little or no BEMF in a motor winding the current increases quickly. Alternatively, one can look directly at the BEMF. BEMF is directly proportional to angular velocity, so motor speed can be monitored by monitoring BEMF. Suitable methods for detecting stepper-motor stall are disclosed in the article “Back-EMF method detects stepper motor stall” of D. Swanson and R. Stejskal, STMicroelectronics, Jan. 5, 2012 (available at the website of www.edn.com). Suitable examples of methods for sensorless magnetic field control of a motor can be found in U.S. 2006/038517, herewith incorporated by reference.

The displacement device may for instance include a stirrer in a container or canister for storing the coating composition. Such containers are for example used in paint delivery systems. The stirrer serves to homogenize the coating composition to prevent sagging. The stirrer can for example be driven by an AC or DC electromotor, while the sensor comprises a current measurement circuit.

A dispensing unit can be connected to an outlet of the container. In case of a sudden drop of the determined motor torque the control unit can stop dispensing.

Optionally, the control unit can be programmed to provide user feedback when the determined parameter passes a threshold value. For instance, a user interface can be used informing an operator whether or not the condition of the liquid is good, critical or unusable. It may for instance use a code “Green” informing an operator that the system is well within a predefined operating window, code “Orange” if the systems is in a critical range and code “Red” if the system is too critical to operate and maintenance or repair are needed.

Optionally, the at least one sensor may include one or more pressure sensors in a flow path in the liquid displacement device, one or more flow sensors in a flow path in the liquid displacement device and/or one or more weight sensors, such as a weighing scale weighing an amount of the coating composition dispensed by the liquid displacement device.

In a further aspect, a method is disclosed for processing a coating composition using a liquid displacement device driven by a motor, wherein a control unit generates a signal on basis of resistance encountered by the motor. The signal can be used as user feedback to indicate the condition of the coating composition. Optionally, the motor can be controlled on basis of the determined resistance encountered by the motor.

In this method a stepper motor may be used. This makes it possible to increase the rotational speed of the rotor of the motor until the stepper motor stalls. The control unit can then be used to calculate the required signal on basis of the rotor speed when the motor stalls. The stalling of the motor can for example be detected by an encoder and/or a home sensor.

### BRIEF DESCRIPTION OF THE DRAWINGS

FIG. 1: shows an exemplary embodiment of a coating composition processing apparatus;

FIG. 2: shows schematically a container of the apparatus of FIG. 1;

FIG. 3: shows schematically a dispenser with a motor of the apparatus of FIG. 1;

FIG. 4: shows current consumption as a function of motor torque;

FIG. 5: shows motor torque as a function of motor speed;

FIG. 6: shows motor torque as a function of the number of steps by a stepper motor during a dispense cycle.

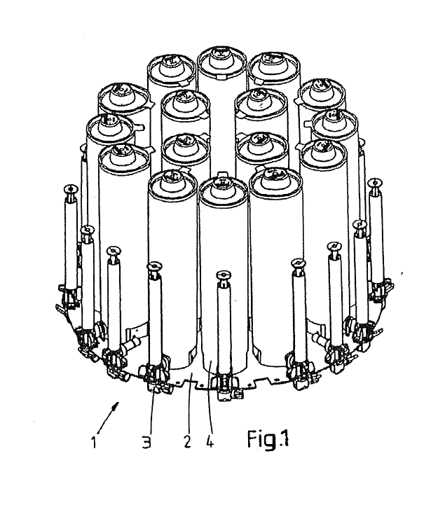

FIG. 1 illustrates the main parts of an exemplary embodiment of an apparatus 1 for dispensing coating compositions, such as colorants, base paints, and paint components for decorative purposes, such as masonry paints, and/or industrial purposes. The dispensing apparatus 1 includes a turntable 2, which is rotatable about a vertical axis by means of a drive (not shown) in order to rotate the turntable 2 between discrete positions. On the turntable 2, there are mounted a plurality of pumps 3, e.g., sixteen pumps. Each pump 3 is associated with a fluid container 4.

Each container 4 contains a paint module or pigment paste.

To deliver a paint of a user specified colour or quality, a control unit selects the required paint modules or pigment pastes. Subsequently, the required amount of each selected paint module or pigment paste is dispensed into a collection container (not shown) to form the desired paint.

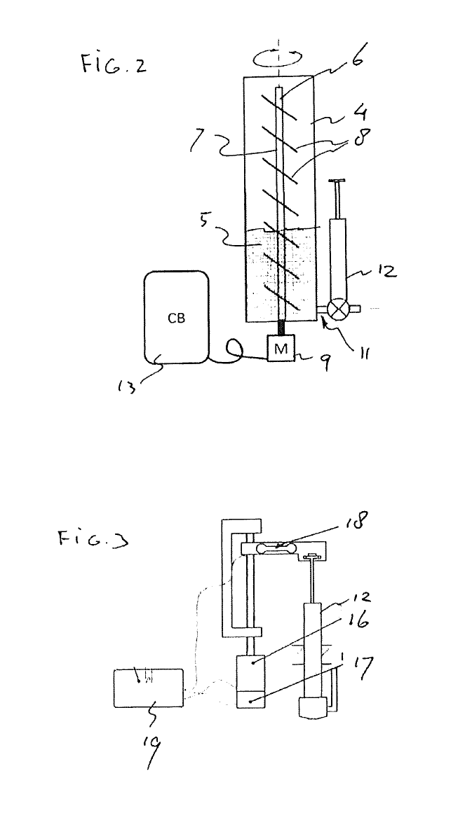

FIG. 2 schematically shows a container 4 in cross section. The container 4 contains a coating composition 5 and comprises a stirrer 6 with a vertical axis 7 with stirring blades 8. The stirrer 6 in this exemplary embodiment is driven by a DC electromotor 9. At the lower side the container 4 is provide with an outlet 11 with a piston pump 12 for dispensing a desired amount of the contained fluid.

To prevent sagging the stirrer 6 stirs the liquid 5 contained in the container 4. The motor 9 drives the stirrer 6 with a given torque. The required torque will vary with the level and the condition of the contained liquid 5. A current measurement circuit 13 determines power consumed by the motor 9. The consumed power is indicative for the resistance encountered by the motor 9 and the condition of the liquid 5. If the used power exceeds a predetermined value, a control unit may provide a signal alerting that the condition of the liquid 5 has become too poor. The container 4 can then be emptied, cleaned and refilled with a fresh amount of liquid. If the used power drops, this may indicate that the container 4 has become empty. The operator can be alerted to refill the container 4.

The piston pump 12 also comprises a motor 16, as shown schematically in FIG. 3. In this exemplary embodiment the motor 16 is a stepper motor with an encoder 17 determining motor speed. A load cell 18 determines torque exerted by the motor 16 to the piston pomp 12. The encoder 17 and the load cell 18 are connected to a control unit 19. At the moment the container 4 is empty, the piston pump 12 receives air instead of liquid and the required torque drops immediately. In response the control unit 19 stops the suction stroke by the piston pump 12 and the dispense is stopped. The dispensed amount of liquid dispensed so far is logged. An operator is alerted to refill the container 4. After refilling the dispensing can be continued and completed.

A dispense cycle contains a sequence of pump actions to deliver a required amount of liquid at a requested flow speed. To perform a dispense cycle the control unit 19 actuates the piston pump 12. The control unit 19 starts at a set motor speed. If the condition of the liquid is good the flow speed of the dispensed liquid will be as expected. If the condition of the liquid is poor, the motor speed determined by the encoder 17 will deviate from the set speed. The control unit 19 will then adjust the electric power and current consumption. If the current consumed by the motor 19 is at its maximum the actual motor speed determined by the encoder is compared with the set speed. The deviation is an indication for the actual condition of the liquid. A signal is generated on basis of the measured deviation to inform the operator.

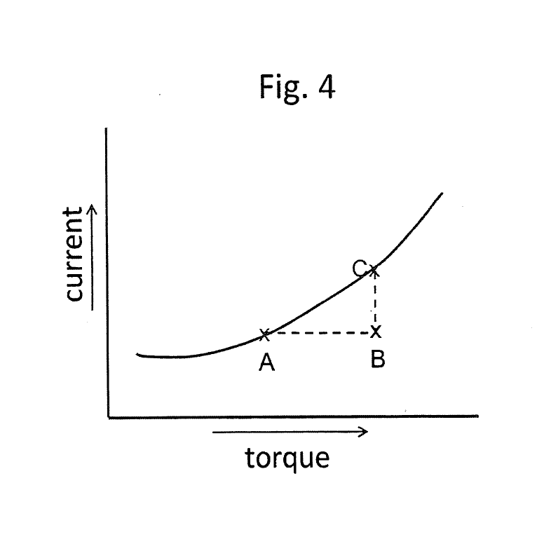

FIG. 4 shows consumed electric current or power as a function of motor torque. At point A pump drive torque and pump drive current are balanced. If the liquid condition deteriorates higher torque is required to pump the liquid (point B). In that case the control unit can increase the current to a higher level (point C). The difference in current consumption between points A and C is an indication for the change of the condition of the processed liquid.

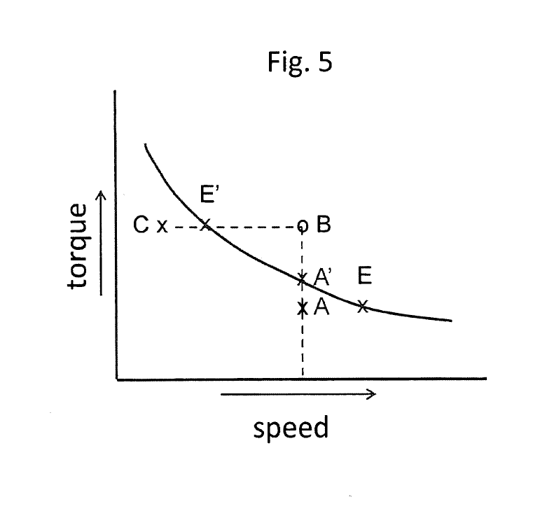

FIG. 5 shows maximum available motor torque as a function of motor speed. With prior art systems, the motor torque is maintained at a level below the maximum available motor torque at that speed to allow the system to coop with variations in the condition of the liquid. Referring to FIG. 5, at a given motor speed the motor torque is set at a level A, a certain percentage below the maximum motor torque available at that motor speed. When the condition of the liquid deteriorates to such extent that it requires a motor torque B at the given speed value, the motor speed is reduced to the motor speed at point C. This is again below the maximum available torque at that speed. The present disclosure makes it possible to use the maximum available motor torque at each motor speed value.

Accordingly, the torque at point A may now perform with a higher motor speed E. When the condition of point B would occur the control unit will reduce the speed to E′ instead of C. Under all conditions the motor speed is higher than with the prior art settings.

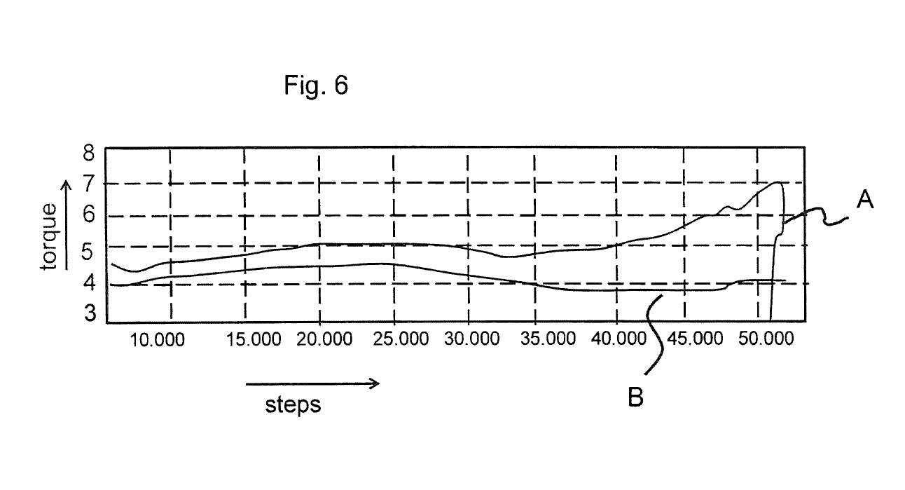

With the configuration of FIG. 3 it is possible to compare measured torque as a function of time, e.g., expresses as the number of counted steps of a stepper motor (e.g. curve A in FIG. 6). This can be compared with a reference function of a correctly performed dispense cycle (curve B in FIG. 6). Curve A in FIG. 6 shows a sudden drop of motor torque, indicating that the contained is empty. By comparing the measured curve with the reference curve during the dispense cycle the control unit may adjust the pump drive performance or even stop dispensing, e.g., when the container is empty.

1. An apparatus for processing coating compositions, the apparatus comprising:
at least one liquid displacement device;
at least one sensor for determining flow behaviour of a coating composition in the liquid displacement during operation of the device;
a control unit responsive to output signals from the sensor to generate a parameter representing rheological quality of the coating composition.

2. An apparatus according to claim 1, comprising at least one motor for driving the liquid displacement device, wherein the sensor is a sensor for determining one or more motor performance parameters corresponding to resistance encountered by the motor.

3. An apparatus according to claim 1, wherein the determined parameter includes torque exerted by the motor, motor speed and/or current consumption.

4. An apparatus according to claim 1, wherein the sensor comprises a load cell, an encoder and/or a current measurement circuit.

5. An apparatus according to claim 1, wherein the control unit adjusts the speed of the motor on basis of the determined torque.

6. An apparatus according to claim 5, wherein the control unit is programmed to generate a feedback signal on basis of the change in electric current consumed by the motor resulting from the change of speed.

7. An apparatus according to claims 1, wherein the liquid displacement device includes a pump, such as a piston pump or a rotary pump.

8. An apparatus according to claim 1, wherein the parameter is determined during a displacement stroke by the pump, and wherein the control unit is programmed to compare the determined parameter with a set value as a function of time and/or temperature.

9. An apparatus according to claim 7, wherein the pump is part of a dispenser, e.g., a dispenser of a paint delivery system.

10. An apparatus according to claim 7, wherein the motor is an electromotor provided with an encoder, wherein the parameter includes rotor movement detected by the encoder.

11. An apparatus according to claim 7, wherein the motor is a stepper motor provided with a home sensor and/or an absolute encoder, wherein the parameter includes the number of steps required to return the rotor of the stepper motor to a defined home position.

12. An apparatus according to claim 10, wherein the control unit is programmed to adjust power feed to the motor if the detected rotor movement deviates from a set value.

13. An apparatus according to claim 10, wherein the control unit is programmed to calculate a signal indicative for the condition of the coating composition on basis of the difference between the determined rotor movement and the set value.

14. An apparatus according to claim 10, wherein the one or more displacement devices include a stirrer in a container for storing the coating composition.

15. An apparatus according to claim 14, wherein the motor for driving the stirrer comprises a DC electromotor and wherein the sensor comprises a current measurement circuit.

16. An apparatus according to claim 14, wherein a dispensing unit is connected to an outlet of the container and wherein the control unit is programmed to stop dispensing in response to a drop of the determined torque of the motor driving the stirrer.

17. An apparatus according to claim 14, wherein the control unit is programmed to provide user feedback when the determined parameter passes a threshold value.

18. An apparatus according to claim 14, wherein the one or more motors include an electromotor, e.g., a stepper motor.

19. An apparatus according to claim wherein the at least one sensor includes one or more pressure sensors in a flow path in the liquid displacement device.

20. An apparatus according to claim wherein the at least one sensor includes one or more flow sensors in a flow path in the liquid displacement device.

21. An apparatus according to claim wherein the at least one sensor includes one or more weight sensors, such as a weighing scale weighing an amount of the coating composition dispensed by the liquid displacement device.

22. A method for processing a coating composition using a liquid displacement device driven by a motor, wherein a control unit generates a signal on basis of resistance encountered by the motor.

23. A method according to claim 22, wherein the signal is used as user feedback to indicate the condition of the coating composition.

24. A method according to claim 22, wherein the motor is controlled on basis of the determined resistance encountered by the motor.

25. A method according to claim 22, wherein the motor is a stepper motor and wherein the rotational speed of the rotor of the motor is increased until the stepper motor stalls and wherein the control unit calculates said signal on basis of the rotor speed when the motor stalls.

26. A method according to claim 25, wherein the stalling of the motor is detected by an encoder and/or a home sensor.
